(19) United States
(12) Patent Application Publication
(10) Pub. No.: US 2009/0031378 A1
(43) Pub. Date: Jan. 29, 2009

(54) MEDIA DEVICE AND METHOD FOR TRANSMITTING BROADCAST PROGRAM

(75) Inventor: Hyo-joon KIM, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/015,786

(22) Filed: Jan. 17, 2008

(30) Foreign Application Priority Data
Jul. 27, 2007 (KR) 10-2007-0075601

(51) Int. Cl. H04N 7/173

(52) U.S. Cl. 725/109

(57) ABSTRACT

A media device and a method for transmitting broadcast programs are provided. The media device includes an external interface which is communicably connected to an external device, a broadcast receiving unit which receives a broadcast program, a storage unit which stores the broadcast program received by the broadcast receiving unit, and a control unit automatically transmits a certain broadcast program to the external device connected via the external interface if the certain broadcast program, which is previously selected by a user from among broadcast programs received by the broadcast receiving unit, is stored in the storage unit. Accordingly, the latest broadcast programs can be transmitted without the user identifying the broadcast programs and personally transmitting broadcast programs to the portable media player every time.

### CROSS-REFERENCE TO RELATED APPLICATIONS

This application claims priority under 35 U.S.C. § 119 from Korean Patent Application No. 10-2007-0075601, filed on Jul. 27, 2007 in the Korean Intellectual Property Office, the disclosure of which is incorporated herein by reference in its entirety.

### BACKGROUND OF THE INVENTION

1. Field of the Invention

Apparatuses and methods consistent with the present invention relate to transmitting broadcast programs, and more particularly, to a media device which transmits desired broadcast programs to a portable media player, and a control method thereof.

2. Description of the Related Art

Modern media devices having a personal video recorder (PVR) function are capable of storing broadcast programs to be viewed by a user. As wireless Internet has become widespread and portable media players are more widely used, users increasingly view recorded broadcast programs at any time or place using portable media players, rather than using the media devices with a PVR function on which the broadcast programs were originally stored.

However, in order to transmit the stored broadcast programs to portable media players, first, the broadcast programs must be transmitted to a personal computer, and are converted into a file format which can be reproduced in portable media players, and the converted broadcast programs are transmitted to portable media players. This process is complicated and inconvenient.

Furthermore, when an environment in which broadcast programs can be transmitted is constructed at home, if there are various types of viewable or audible broadcasts such as a terrestrial television, a cable television, an Internet Protocol Television (IPTV), and an Internet radio, or there are many desired programs of one broadcast type, there is a need for methods to integrally manage those programs, and transmit broadcast programs to a portable media player.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

The present invention provides a media device which stores desired broadcast programs according to a simple setting made by a user and automatically transmits the broadcast programs to a portable media player, so that the user does not need to identify the broadcast programs and transmit the broadcast programs individually to the portable media player, and many media devices can be integrally controlled, and a method for transmitting broadcast programs.

According to an exemplary aspect of the present invention, there is provided a media device including an external interface which is communicably connected to an external device, a broadcast receiving unit which receives a broadcast program, a storage unit which stores the broadcast program received by the broadcast receiving unit, and a control unit which controls to automatically transmit a certain broadcast program to the external device connected via the external interface if the certain broadcast program which is previously selected by a user from among broadcast programs received by the broadcast receiving unit is stored in the storage unit.

The control unit writes storage information including at least one of a unique address, a broadcast list, and a storage date of the broadcast program.

The external interface comprises a network address to connect to a certain network, and the control unit provides the external device, which is connected using the network address, with the storage information.

If the external device where the unique address is input is connected to the media device via the external interface, the control unit identifies the certain broadcast program corresponding to the unique address input in the external device based on the storage information, and transmits the certain broadcast program to the external device.

When the certain broadcast program is stored in the storage unit, if there is insufficient space in the storage unit, the control unit stops storing the certain broadcast program, or deletes the oldest stored broadcast program from among stored certain broadcast programs according to the user settings.

According to another exemplary aspect of the present invention, there is provided a method for transmitting a broadcast program, including storing a certain broadcast program which is previously selected by a user from among broadcast programs which are able to be received, and automatically transmitting the certain stored broadcast program to a connected external device.

The method further includes writing storage information including at least one of a unique address, a broadcast list, and a storage date of the broadcast program.

In the storing of the certain broadcast program, if there is insufficient storage space, storing the certain broadcast program is stopped, or the oldest stored broadcast program is deleted from among stored certain broadcast programs according to the user settings.

The certain broadcast program corresponding to the unique address input in the external device is identified, and the certain broadcast program is transmitted to the external device.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a schematic diagram illustrating media devices and an external device which are connected via a home network according to an exemplary embodiment of the present invention;

FIGS. 2A to 2C are block diagrams illustrating a media device according to an exemplary embodiment of the present invention;

FIG. 3 shows storage information on broadcast programs according to an exemplary embodiment of the present invention; and

FIG. 4 is a flow chart illustrating a method for transmitting broadcast programs according to an exemplary embodiment of the present invention.

### DETAILED DESCRIPTION OF EXEMPLARY EMBODIMENTS OF THE INVENTION

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in detail since they would obscure the invention with unnecessary detail.

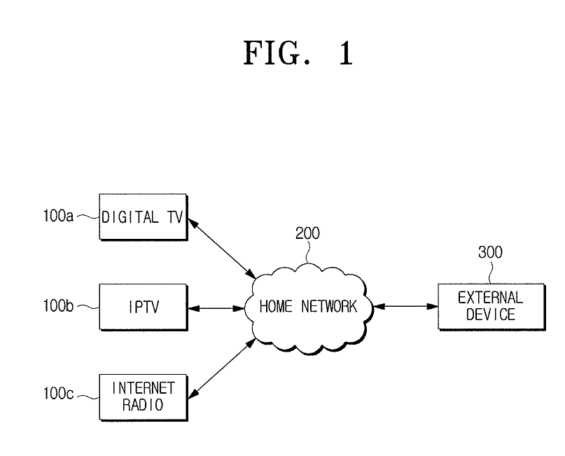

FIG. 1 is a schematic diagram illustrating media devices and an external device which are connected via a home network according to an exemplary embodiment of the present invention.

As shown in FIG. 1, media devices, which receive broadcast signals and reproduce or store the broadcast signals, such as a digital television 100a, an IPTV 100b, an Internet radio 100c, are connected to an external device 300 which reproduces media files via a wired or wireless home network 200.

The external device 300 may be a portable media player, such as a portable multimedia player (PMP), an MP3 player, a personal digital assistant (PDA), a personal computer, or a notebook computer, which stores and reproduces media files. The external device 300 receives a unique address corresponding to a broadcast program selected by the user.

The media devices store broadcast programs according to a user's recording settings, and transmit a broadcast program corresponding to the unique address input in the external device 300 when the media devices are connected to the external device 300 via the home network 200.

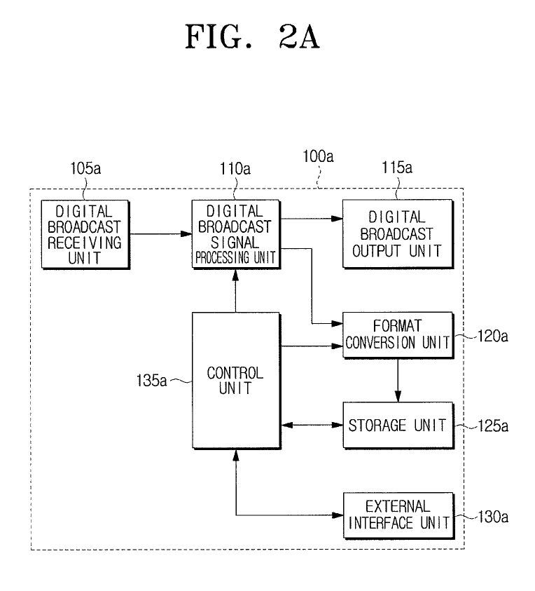

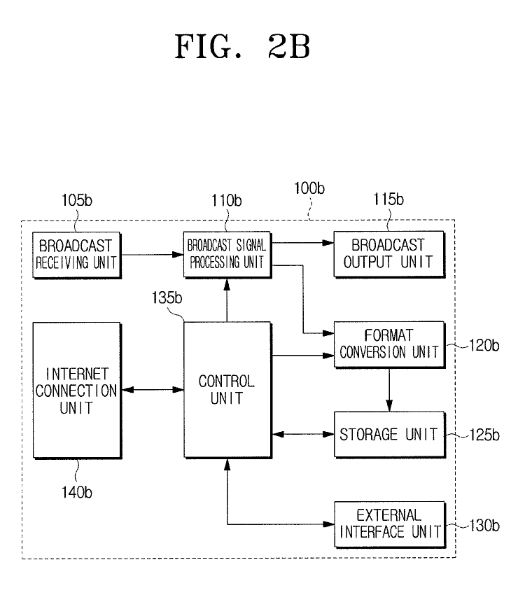

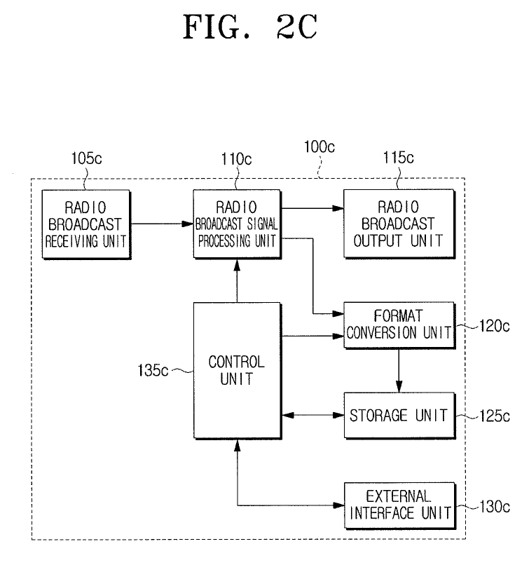

The media devices according to the exemplary embodiment of the present invention are described in more detail. FIGS. 2A to 2C are block diagrams illustrating a media device according to an exemplary embodiment of the present invention.

As shown in FIG. 2A, the digital television 100a includes a digital broadcast receiving unit 105a, a digital broadcast signal processing unit 110a, a digital broadcast output unit 115a, a format conversion unit 120a, a storage unit 125a, an external interface unit 130a, and a control unit 135a.

The digital broadcast receiving unit 105a tunes to a digital broadcast signal received through an antenna or a cable using a tuner (not shown), and transmits the digital broadcast signal to the digital broadcast signal processing unit 110a.

The digital broadcast signal processing unit 110a separates an audio signal, a video signal, and additional data from the digital broadcast signal, and processes these signals.

The digital broadcast output unit 115a outputs the processed digital broadcast signal using a display apparatus or a speaker.

The format conversion unit 120a converts the processed digital broadcast signal into a certain format. The converted broadcast signal is stored in the storage unit 125a.

The external interface unit 130a is communicably connected to the external device 300, and is connected to the home network so the external interface unit 130a can have a unique network address.

The control unit 135a controls the entire operation of the digital television 100a. That is, the control unit 135a stores digital broadcast programs received according to the user's recording setting, and transmits stored digital broadcast programs to the external device 300 when the external device 300 is connected. More detailed description of the control unit 135a will be given below.

As shown in FIG. 2B, the IPTV 100b includes a broadcast receiving unit 105b, a broadcast signal processing unit 110b, a broadcast output unit 115b, a format conversion unit 120b, a storage unit 125b, an external interface unit 130b, a control unit 135b, and an Internet connection unit 140b.

The broadcast receiving unit 105b tunes to a broadcast program received through an antenna or a cable, and transmits the broadcast program to the broadcast signal processing unit 110b. The broadcast program is processed in the broadcast signal processing unit 110b, and output through the broadcast output unit 115b.

The broadcast program processed in the broadcast signal processing unit 110b is converted into a certain format in the format conversion unit 120b, and stored in the storage unit 125b.

If the IPTV 100b is connected to the external device 300 via the external interface unit 130b connected to the home network, the broadcast program stored in the storage unit 125b is selectively transmitted to the external device 300 through the external interface unit 130b.

Internet connection unit 140b is connected to the Internet to provide a variety of content, such as Internet searching, images, data, and additional services.

As shown in FIG. 2C, the Internet radio 100c includes a radio broadcast receiving unit 105c, a radio broadcast signal processing unit 110c, a radio broadcast output unit 115c, a format conversion unit 120c, a storage unit 125c, an external interface unit 130c, and a control unit 135c.

The radio broadcast receiving unit 105c receives a radio broadcast program through the Internet, and transmits the radio broadcast program to the radio broadcast signal processing unit 110c.

The radio broadcast signal processing unit 110c processes the radio broadcast program, and outputs the radio broadcast program through the radio broadcast output unit 115c.

The format conversion unit 120c converts the processed radio broadcast program into a certain format. The converted broadcast program is stored in the storage unit 125c.

If the external interface unit 130a connected to the home network is connected to the external device 300, the radio broadcast program stored in the storage unit 125c is selectively transmitted to the external device 300 through the external interface unit 130c.

The media devices according to the exemplary embodiment of the present invention as described above store broadcast programs from among the received broadcast programs according to the user's recording setting, and selectively transmit the stored broadcast programs when the external device 300 is connected.

In more detail, the operation of the control unit 135a of the digital television 100a in FIG. 2A is described.

A user selects a certain program, and sets recording of the program. That is, the user selects a certain program from among programs which are broadcast at a certain time or broadcasted daily or weekly, and sets recording of the program.

The control unit 135a stores the broadcast program in the storage unit 125a based on the setting of recording. At this time, the broadcast program is stored in a certain file format, which is a file format which can be reproduced in the external device 300 connected through the external interface unit 130a.

The control unit 135a generates storage information including a unique address, a broadcast list, and a storage date of the broadcast program.

The unique address is an address allocated in the broadcast program, which includes an address indicating the broadcast program in addition to a network address allocated in the home network connected to the external interface unit 130a.

The unique address is used to determine whether to transmit the stored broadcast program between the media device and the external device 300 in the home network in the same manner as an address used in a Podcast, which has become widely used recently.

Briefly, the Podcast generally provides users of portable media players content, such as news, soap operas, or sports, in an audio file or a video file, so unlike conventional radio programs, users download programs from a server and listen to the programs, which are automatically updated, at any time without needing to listen to radio on broadcast time.

The broadcast list is a list where a certain broadcast program is broadcast and collected at a certain time daily or weekly.

The storage date is a date or time when the broadcast program is stored.

When the broadcast program is stored in the storage unit 125a, if there is insufficient space on the storage unit 125a, the control unit 135a stops storing the broadcast program, or deletes the oldest stored broadcast program from among the stored broadcast programs and stores the broadcast program according to the user settings.

The control unit 135a displays the storage information on the broadcast program through the digital broadcast output unit 115a or transmits the storage information to the external device 300 connected through the external interface unit 130a.

Therefore, the user identifies the storage information which is displayed on the digital television 100a or transmitted to the external device 300, selects a desired broadcast program, and inputs the unique address of the desired broadcast program to the external device 300.

If the external device 300 where the unique address is input by the user's selection is connected to the digital television 100a via the home network, the control unit 135a compares the unique address input in the external device 300 with the storage information, and determines whether or not there are broadcast programs corresponding to the unique address, and which broadcast programs are transmitted.

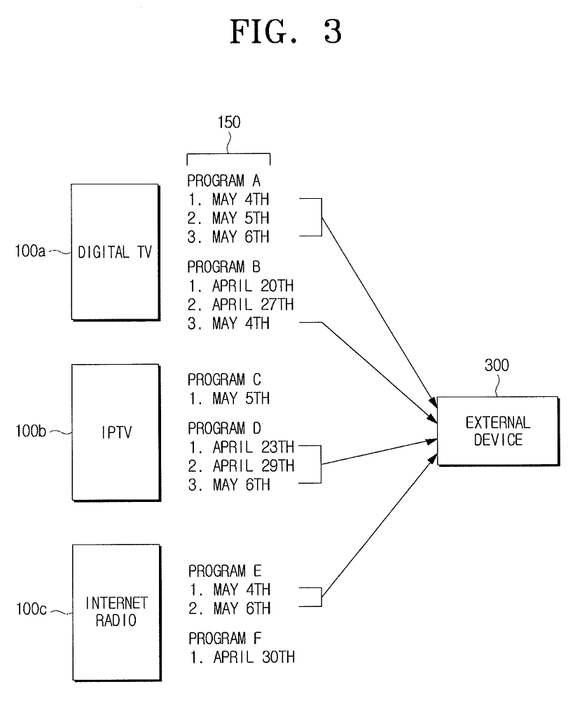

More detailed description is provided with reference to FIG. 3. FIG. 3 shows storage information on broadcast programs according to an exemplary embodiment of the present invention.

In FIG. 3, the digital television 100a, the IPTV 100b, and the Internet radio 100c have storage information, respectively. Unique addresses of programs A, B, D, and E are input in the external device 300 by the user's selection.

The control unit 135a of the digital television 100a identifies that unique addresses of programs A and B, which are input in the external device 300. Subsequently, the control unit 135a determines whether broadcasts 1, 2, and 3 in the broadcast list of program A are stored in the external device 300, and transmit non-stored broadcasts 1, 2, and 3 to the external device 300 if broadcasts 1, 2, and 3 in the broadcast list of program A are not stored in the external device 300.

The control unit 135a determines whether broadcasts 1, 2, and 3 in the broadcast list of program B are stored in the external device 300, and transmits non-stored broadcast 3 to the external device 300 if broadcasts 1 and 2 in the broadcast list of program B are stored in the external device 300 and broadcast 3 is not stored.

The IPTV 100b, and the Internet radio 100c transmits broadcast programs selected by the user to the external device 300 in the same process as the digital television 100a.

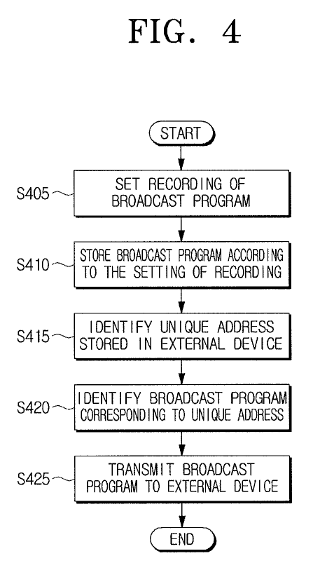

A method for transmitting broadcast programs using a media device as shown in FIG. 2A is described with reference to FIG. 4. FIG. 4 is a flow chart illustrating a method for transmitting broadcast programs according to an exemplary embodiment of the present invention.

In operation S405, the control unit 135a sets recording of a certain program according to the user's input. That is, the user selects a certain program from among programs which are broadcast at a certain time or broadcast daily or weekly, and sets to record the program.

In operation S410, the control unit 135a stores the broadcast program in the storage unit 125a based on the setting of recording. At this time, the broadcast program is stored in a certain file format, which is a file format which can be reproduced in the external device 300 connected through the external interface unit 130a.

When the broadcast program is being stored in the storage unit 125a, if there is insufficient space on the storage unit 125a, the control unit 135a stops storing the broadcast program, or deletes the oldest stored broadcast program from among the stored broadcast programs and stores the broadcast program according to the settings.

In addition, the control unit 135a writes storage information including a unique address, a broadcast list, and a storage date of the broadcast program.

In operation S415, if the external device 300 where the unique address is input by the user's selection is connected to the digital television 100a via the home network, the control unit 135a identifies the unique address input in the external device 300.

Additionally, in operation S420, the control unit 135a identifies the broadcast program corresponding to the unique address input in the external device 300. That is, the control unit 135a identifies the broadcast list of the broadcast program corresponding to the unique address, and determines whether there is any program in the external device 135a, which overlaps with the programs on the broadcast list.

In operation S425, the control unit 135a transmits non-overlapping programs to the external device 300.

Other media devices such as the IPTV 100b, and the Internet radio 100c transmits broadcast programs selected by the user to the external device 300 in the same process as the digital television 100a.

As described above, the user selectively inputs unique addresses of desired broadcast programs to the external device 300, and the external device 300 is connected to media devices via the home network, so that latest broadcast programs can be automatically stored in the external device 300 without personally selecting and identifying broadcast programs every time.

The exemplary embodiment is described merely as an example, so terms used in the exemplary embodiment are not for limitation, but for explanation.

For example, in the above exemplary embodiment, a digital television, an IPTV, and an Internet radio are presented as media devices, but media devices are not limited thereto, and include media devices having a function of receiving and storing broadcast signals.

Furthermore, in the above exemplary embodiment, the media devices are connected to the external device 300 via the home network, but they may be connected to the external device 300 directly.

As can be appreciated from the above description, desired broadcast programs are stored by a simple setting of a user and are automatically transmitted to a portable media player, so that the latest broadcast programs can be transmitted without the user identifying the broadcast programs and personally transmitting broadcast programs to the portable media player every time, and many media devices can be integrally controlled.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A media device comprising:
an external interface which is communicably connected to an external device;
a broadcast receiving unit which receives a broadcast program;
a storage unit which stores the broadcast program received by the broadcast receiving unit; and
a control unit automatically transmits a certain broadcast program to the external device connected via the external interface if the certain broadcast program, which is previously selected from among broadcast programs received by the broadcast receiving unit, is stored in the storage unit.

2. The media device of claim 1, wherein the control unit generates storage information including at least one of a unique address, a broadcast list, and a storage date of the broadcast program.

3. The media device of claim 1, wherein the external interface comprises a network address to connect to a certain network, and
the control unit provides the external device, which is connected using the network address, with the storage information.

4. The media device of claim 2, wherein if the external device is connected to the media device via the external interface, the control unit identifies the certain broadcast program corresponding to the unique address input in the external device based on the storage information, and transmits the certain broadcast program to the external device.

5. The media device of claim 2, wherein when the certain broadcast program is stored in the storage unit, if there is insufficient space in the storage unit, the control unit stops storing the certain broadcast program, or deletes an oldest stored broadcast program from among stored certain broadcast programs.

6. A method for transmitting a broadcast program, the method comprising:
storing a certain broadcast program which is previously selected from among broadcast programs which are able to be received; and
automatically transmitting the certain stored broadcast program to an external device.

7. The method of claim 6, further comprising generating storage information including at least one of a unique address, a broadcast list, and a storage date of the broadcast program.

8. The method of claim 7, wherein in the storing the certain broadcast program, if there is insufficient storage space, the storing the certain broadcast program is stopped, or an oldest stored broadcast program is deleted from among stored certain broadcast programs.

9. The method of claim 7, wherein the certain broadcast program corresponding to the unique address input in the external device is identified, and the certain broadcast program is transmitted to the external device.

10. The method of claim 8, wherein an oldest stored broadcast program is deleted from among stored certain broadcast programs according to user settings.
